(19) United States
(12) Patent Application Publication
(10) Pub. No.: US 2013/0234557 A1
(43) Pub. Date: Sep. 12, 2013

(54) ROTOR FOR ELECTRIC MOTOR INCLUDING ROTATIONAL SHAFT AND YOKE SECURELY FITTED ON THE ROTATIONAL SHAFT

(71) Applicant: FANUC CORPORATION, Yamanashi (JP)

(72) Inventors: Kouji KOBAYASHI, Yamanashi (JP); Takeshi TAMAKI, Yamanashi (JP)

(73) Assignee: FANUC CORPORATION, Yamanashi (JP)

(21) Appl. No.: 13/780,801

(22) Filed: Feb. 28, 2013

(30) Foreign Application Priority Data
Mar. 12, 2012 (JP) 2012054641

(51) Int. Cl. H02K 1/28

(52) U.S. Cl. CPC H02K 1/28
USPC 310/216.123

(57) ABSTRACT

According to the present invention, in a rotor of an electric motor including a rotational shaft and a yoke fitted on an outer circumferential surface of the rotational shaft, fitting between an inner circumferential surface of the yoke and the outer circumferential surface of the rotational shaft is interference fit. Further, fitting between a convex portion (or concave portion) formed on the outer circumferential surface of the rotational shaft and a concave portion (or convex portion) formed on the inner circumferential surface of the yoke is also interference fit.

### BACKGROUND OF THE INVENTION

1. Field of the Invention

The present invention relates to a rotor for an electric motor including a rotational shaft and a yoke fitted on the rotational shaft.

2. Description of the Related Art

In a rotor for an electric motor, fitting between a yoke and a shaft is generally carried out by means of shrinkage fit. However, in a rotor for a small-sized electric motor with a thinner yoke, fitting allowance has to be strictly controlled so that the yoke undergoes elastic deformation during a shrinkage fit process. Thus, it is necessary to form an inner diameter of the yoke and an outer diameter of the shaft with high precision. Such forming with high precision tends to increase the cost. In addition, it is difficult to increase precision of a punching process, which is generally carried out in order to form the yoke as a stacked structure of steel plates. Without a sufficient degree of precision, the yoke undergoes plastic deformation, which could result in reduced fastening force, and therefore misalignment of the yoke.

It is known to fit a yoke and a shaft on each other by means of an adhesive. However, the process is rather complicated because of a need to control the amount of adhesive, clean the yoke and the shaft, and remove excessive adhesives, and therefore, quality control may be challenging. It is also known to fasten a yoke and a shaft together by fitting a key into a keyway. However, a key structure for fastening the yoke and the shaft provides relatively small fastening force in an axial direction, while providing large fastening force in a rotational direction. Therefore, it is necessary to provide separate fixing means in an axial direction, complicating the structure. JP-A-61-266041 and JP-A-2002-295500, which disclose the related art, should also be referred to.

Therefore, there is a need for a motor for an electric motor including a rotational shaft and a yoke fitting on the rotational shaft, in which separate fixing means and adhesives are not required.

### SUMMARY OF THE INVENTION

According to a first aspect, a rotor for an electric motor comprises: a rotational shaft having a cylindrical contour and capable of rotating around an axis; and a yoke fitted on an outer circumferential surface of the rotational shaft, wherein the rotational shaft has on the outer circumferential surface at least one concave portion or convex portion extending in parallel to the axis, wherein the yoke has on an inner circumferential surface a convex portion or a concave portion extending in parallel to the axis and adapted to be fitted on the at least one concave portion or convex portion of the rotational shaft, and wherein fitting between the outer circumferential surface of the rotational shaft and the inner circumferential surface of the yoke is interference fit, and fitting between the concave portion or the convex portion of the rotational shaft and the convex portion or the concave portion of the yoke is interference fit.

According to a second aspect, in the rotor for an electric motor according to the first aspect, the concave portion of the rotational shaft or the yoke has an enlarged portion having a width in a direction perpendicular to the axis, the width gradually increasing toward at least one end of the concave portion.

According to a third aspect, in the rotor for an electric motor according to the second aspect, the concave portion of the rotational shaft or the yoke has a widened portion extending from a tip end of the enlarged portion and having a constant width in a direction perpendicular to the axis.

According to a fourth aspect, in the rotor for an electric motor according to any one of the first to third aspects, the rotational shaft has at at least one end of the rotational shaft a smaller diameter portion having an outer diameter smaller than an inner diameter of the yoke.

According to a fifth aspect, in the rotor for an electric motor according to the second or third aspect, the rotational shaft has at at least one end of the rotational shaft a smaller diameter portion having an outer diameter smaller than an inner diameter of the yoke, the smaller diameter portion extending from the at least one end of the rotational shaft to an end of the enlarged portion situated distant from the at least one end of the rotational shaft.

According to a sixth aspect, in the rotor for an electric motor according to the fourth or fifth aspect, the smaller diameter portion has a tapered shape which gradually decreases in an outer diameter toward the at least one end of the rotational shaft where the smaller diameter portion is situated.

According to a seventh aspect, in the rotor for an electric motor according to any one of the first to sixth aspects, a plurality of the concave portions or the convex portions are situated on the outer circumferential surface of the rotational shaft or the inner circumferential surface of the yoke at an equal distance from each other.

According to an eighth aspect, in the rotor for an electric motor according to any one of the first to seventh aspects, the yoke has a stacked structure of steel plates.

These and other objects, features and advantages of the present invention will become more apparent in light of the detailed description of exemplary embodiments thereof as illustrated by the drawings.

### BRIEF DESCRIPTION OF THE DRAWINGS

FIG. 1 is a perspective view illustrating a rotor including a rotational shaft and a yoke according to one embodiment of the present invention.

FIG. 2 is a sectional view illustrating the yoke in the embodiment of FIG. 1.

FIG. 3 is a sectional view illustrating the rotational shaft in the embodiment of FIG. 1.

FIG. 4 is a sectional view illustrating a yoke according to another embodiment of the present invention.

FIG. 5 is a sectional view illustrating a rotational shaft used together with the yoke shown in FIG. 4.

FIG. 6 is an exploded perspective view illustrating a yoke and a rotational shaft of a rotor according to a variant of the present invention.

FIG. 7 is an exploded perspective view illustrating a yoke and a rotational shaft of a rotor according to another variant of the present invention.

FIG. 8 is an exploded perspective view illustrating a yoke and a rotational shaft of a rotor according to yet another variant of the present invention.

FIG. 9 is a sectional view illustrating the yoke and the rotational shaft shown in FIG. 8.

FIG. 10 is an exploded perspective view illustrating a yoke and a rotational shaft of a rotor according to yet another variant of the present invention.

FIG. 11 is a sectional view illustrating the yoke and the rotational shaft shown in FIG. 10.

FIG. 12 is a sectional view illustrating a yoke of a rotor according to yet another variant of the present invention.

FIG. 13 is a sectional view illustrating a yoke of a rotor according to yet another variant of the present invention.

### DETAILED DESCRIPTION

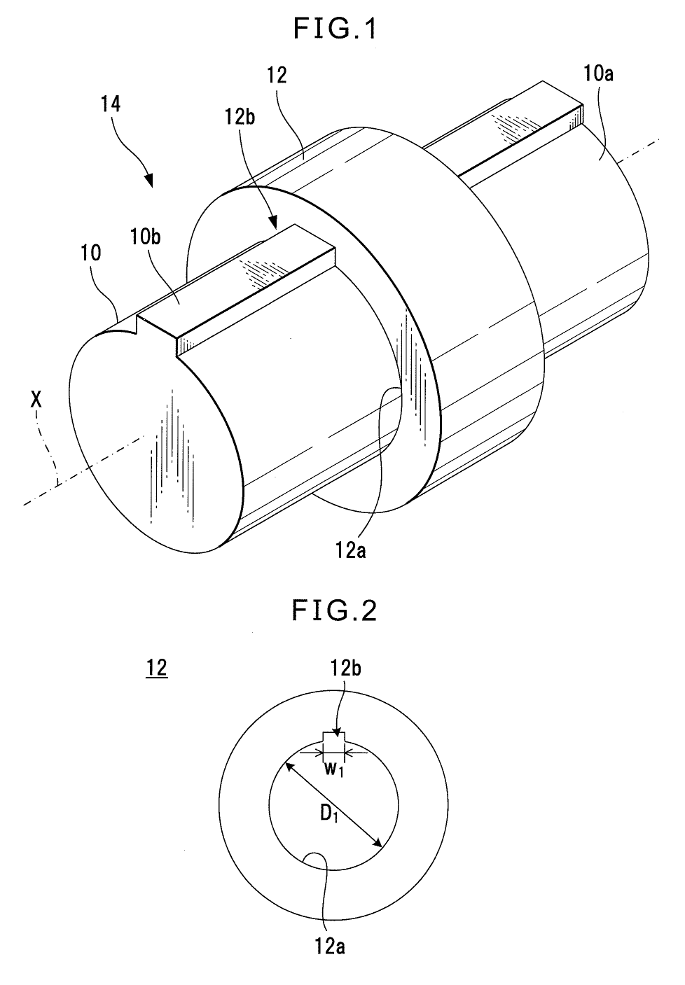

Embodiments of the present invention will be described below with reference to the accompanying drawings. In the illustrated embodiments, each constituent element may be modified in size in relation to another from the practical application for better understanding. FIG. 1 is a perspective view illustrating a rotor 14 including a rotational shaft 10 and a yoke 12 according to one embodiment of the present invention.

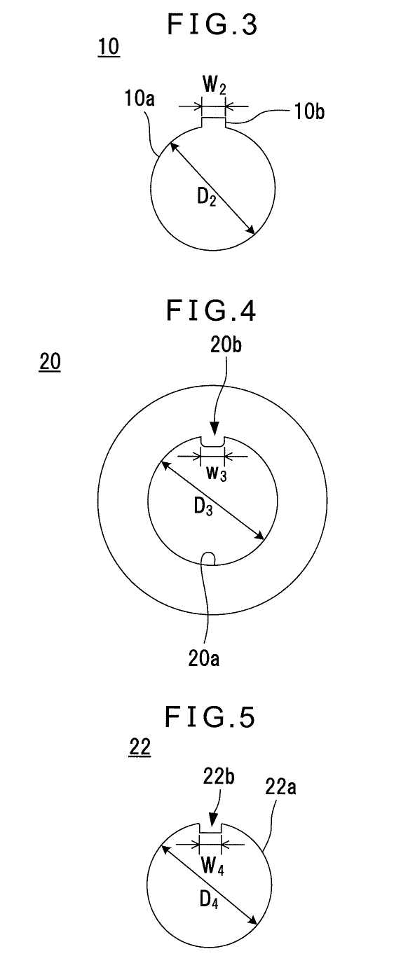

FIG. 2 is a sectional view illustrating the yoke 12 in the embodiment of FIG. 1. FIG. 3 is a sectional view illustrating the rotational shaft 10 in the embodiment of FIG. 1.

The rotor 14 is a rotor used for an electric motor (not shown). As shown in FIG. 1, the rotor 14 includes a rotational shaft 10 having a cylindrical contour and capable of rotating around an axis X, and a yoke 12 fitted on an outer circumferential surface 10a of the rotational shaft 10. The rotational shaft 10 has a convex portion 10b extending in parallel to the axis X on the outer circumferential surface 10a. The yoke 12 has a concave portion 12b extending in parallel to the axis X on an inner circumferential surface 12a, as can be clearly seen in FIG. 2. The convex portion 10b of the rotational shaft 10 is adapted to be fitted on the concave portion 12b of the yoke 12.

Referring to FIG. 2, the yoke 12 is a tubular member having a constant inner diameter D₁ except for portions where the concave portion 12b is provided. The yoke 12 is formed from a magnetic material and serves as a magnetic path during operation of an electric motor. For example, the yoke 12 may have a stacked structure of steel plates. The yoke formed from stacked steel plates is effective to prevent an eddy current from generating. As a result, iron loss is decreased, and efficiency of the electric motor can be improved. In addition, each steel plate may be formed by means of punching, which is inexpensive, so that total manufacturing cost can be reduced. The concave portion 12b extends like a groove on the inner circumferential surface 12a of the yoke 12 and has substantially the same cross-section over the entire length of the yoke 12 in a direction in parallel to the axis X. The concave portion 12b has a width W₁ defined in a direction perpendicular to the axis X.

Referring to FIG. 3, the rotational shaft 10 substantially has a circular cross-section having a constant outer diameter D₂, except for portions where the convex portion 10b is provided. The rotational shaft 10 is a shaft of a rotor for an electric motor, for example. The rotor produces power by rotating around the axis X due to magnetic action in cooperation with a stator of an electric motor, which is not shown. The convex portion 10b protrudes radially outwardly from the outer circumferential surface 10a of the rotational shaft 10. The convex portion 10b has substantially the same cross-section over the entire length of the rotational shaft 10 in a direction in parallel to the axis X. The convex portion 10b has a width W₂ defined in a direction perpendicular to the axis X.

In the present embodiment, D₁<D₂ and W₁<W₂ are satisfied. In other words, the rotational shaft 10 and the yoke 12 are sized in relation to each other so that fitting between the outer circumferential surface 10a of the rotational shaft 10 and the inner circumferential surface 12b of the yoke 12 is interference fit. Likewise, fitting between the convex portion 10b of the rotational shaft 10 and the concave portion 12b of the yoke 12 is interference fit. The respective fitting allowances may be determined accordingly by taking materials of the rotational shaft 10 and the yoke 12 and the size thereof, in particular the thickness of the yoke 12 into consideration.

As described above, according to the present embodiment, both of fitting can be realized by means of interference fit. The interference fit may be shrinkage fit, expansion fit or press-fit, for example. Therefore, according to the present invention, the rotor with reliable quality can be provided, as compared to a rotor in which a yoke is attached to a rotational shaft by means of an adhesive. In addition, a mounting process in the rotor according to the present embodiment is relatively simple, as compared to the case where an adhesive is used, which requires additional processes such as removing excessive adhesives. Thus, a manufacturing process can be easily automated.

With the configuration of the present embodiment, fitting between the outer circumferential surface 10a of the rotational shaft 10 and the inner circumferential surface 12a of the yoke 12 and fitting between the convex portion 10b and the concave portion 12b function to compensate each other, and as a result, a reliable fastening effect can be achieved. For example, if the yoke 12 plastically deforms, fastening force acting between the inner circumferential surface 12a of the yoke 12 and the outer circumferential surface 10a of the rotational shaft 10 may be decreased. Even if this is the case, due to fitting between the convex portion 10b and the concave portion 12b, fastening force acting in the rotor 14 in a rotational direction can be substantially maintained. On the other hand, only with fitting between the convex portion 10b and the concave portion 12b, fastening force acting in a direction of the axis X of the rotor 14 is generally insufficiently small. However, according to the present embodiment, sufficiently great fastening force acts in the direction of the axis X as well, due to the interference fit between the outer circumferential surface 10a of the rotational shaft 10 and the inner circumferential surface 12a of the yoke 12. Therefore, there is no need for additional supporting means for providing support in the axial direction. As a result, the number of parts can be decreased, the structure can be simplified.

It should be noted that smaller fastening force is required in the direction of the axis X, as compared to the rotational direction, in a rotor for an electric motor. Therefore, in the present embodiment, even in the case where the yoke 12 undergoes plastic deformation, fastening force can be sufficiently maintained both in the rotational direction and the direction of the axis X. In addition, since the convex portion 10b and the concave portion 12b are fitted together by means of interference fit, the rotational shaft 10 and the yoke 12 can be prevented from being misaligned relative to each other in the rotational direction. Therefore, fretting can be effectively prevented from occurring, and a more durable rotor can be provided.

Other embodiments and variants of the present invention will be described below. The matters that have been already described in relation to the above embodiment will be omitted in the following explanation. The above matters may be applied to the following embodiments and variants in the same way, unless expressly stated otherwise.

FIG. 4 is a sectional view illustrating a yoke 20 according to another embodiment of the present invention.

FIG. 5 is a sectional view illustrating a rotational shaft 22 used together with the yoke 20. In the present embodiment, the yoke 20 has on an inner circumferential surface 20a a convex portion 20b extending radially inwardly and substantially having a constant width W₃ over the entire length of the yoke 20. Corresponding thereto, the rotational shaft 22 has on an outer circumferential surface 22a a concave portion 22b adapted to be fitted on the convex portion 20b of the yoke 20. In the present embodiment, D₂<D₄ is satisfied, where D₃ is an inner diameter of the yoke 20 and D₄ is an outer diameter of the rotational shaft 22. Further, W₄<W₃ is satisfied, where W₃ is a width of the convex portion 20b of the yoke 20, and W₄ is a width of the concave portion 22b of the rotational shaft 22.

Accordingly, according to the present embodiment, fitting between the inner circumferential surface 20a of the yoke 20 and the outer circumferential surface 22a of the rotational shaft 22 is interference fit, and fitting between the convex portion 20b of the yoke 20 and the concave portion 22b of the rotational shaft 22 is also interference fit. Due to fastening force provided by the interference fit, the yoke 20 and the rotational shaft 22 are securely fastened together both in a rotational direction and an axial direction, similarly to the above embodiment.

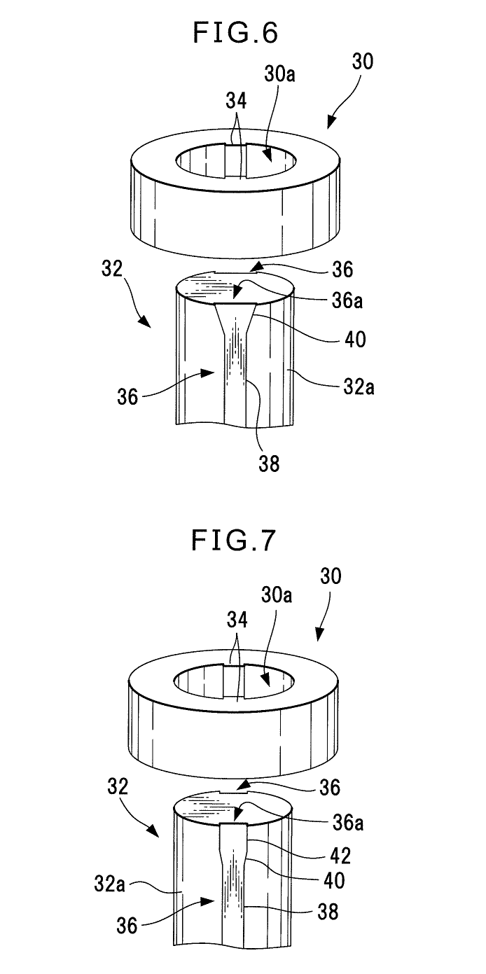

FIG. 6 is an exploded perspective view illustrating a yoke 30 and a rotational shaft 32 of a rotor according to a variant of the present invention. In this variant, similarly to the above embodiment shown in FIGS. 4 and 5, the yoke 30 has on an inner circumferential surface 30a a convex portion 34, and the rotational shaft 32 has on an outer circumferential surface 32a a concave portion 36. More specifically, the yoke 30 has a pair of the convex portions 34 and 34 situated substantially opposite to each other, as illustrated. Similarly, the rotational shaft 32 has a pair of the concave portions 36 and 36 situated substantially opposite to each other, as illustrated. As can be seen in FIG. 6, the concave portion 36 further has a fitting portion 38 sized so as to be fitted on the convex portion 34 by interference fit, and an enlarged portion 40 extending from a tip end of the fitting portion 38. The enlarged portion 40 has a width defined in a direction perpendicular to an axis of the rotational shaft 32, and the width gradually increases toward an end 36a of the concave portion 36. The width of the enlarged portion 40 gradually increases at least to the extent that it becomes larger than a width of the convex portion 34 of the yoke 30. The enlarged portion 40 serves as guiding means, when the yoke 30 is mounted on the rotational shaft 32, and with the aid thereof, the convex portion 34 of the yoke 30 can be smoothly introduced to the concave portion 36 of the rotational shaft 32. Therefore, a mounting process is facilitated and is more efficient, and as a result, manufacturing cost can be reduced.

FIG. 7 is an exploded perspective view illustrating a yoke 30 and a rotational shaft 32 of a rotor according to another variant of the present invention. In FIG. 7, constituent elements which are the same as or correspond to those in FIG. 6 are designated with the same referential numerals, and explanation directed thereto will be omitted to avoid redundancy. In this variant, the concave portion 36 of the rotational shaft 32 has, in addition to an enlarged portion 40 whose width in a direction perpendicular to the axis of the rotational shaft 32 gradually increases toward an end 36a of the concave portion 36, a widened portion 42 extending from a tip end of the enlarged portion 40. The widened portion 42 has a constant width in a direction perpendicular to the axis of the rotational shaft 32, and the width is larger than a width of the convex portion 34 of the yoke 30 and than a width of the fitting portion 38 of the rotational shaft 32. In this variant, similarly to the above variant shown in FIG. 6, the enlarged portion 40 and the widened portion 42 cooperate with each other to function as guiding means when the yoke 30 is mounted on the rotational shaft 32. Therefore, a mounting process is facilitated and is more efficient, and as a result, manufacturing cost can be reduced.

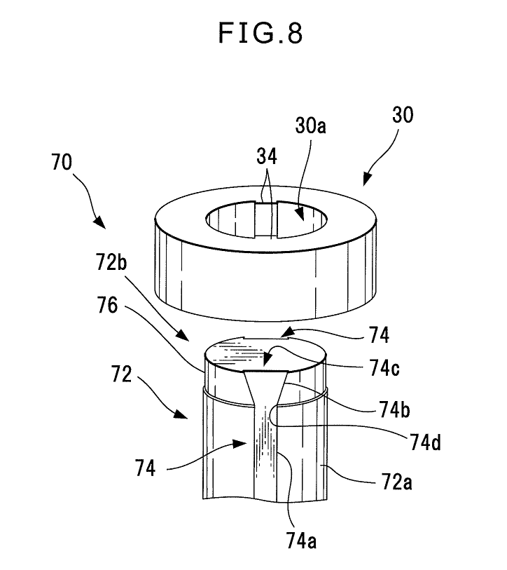

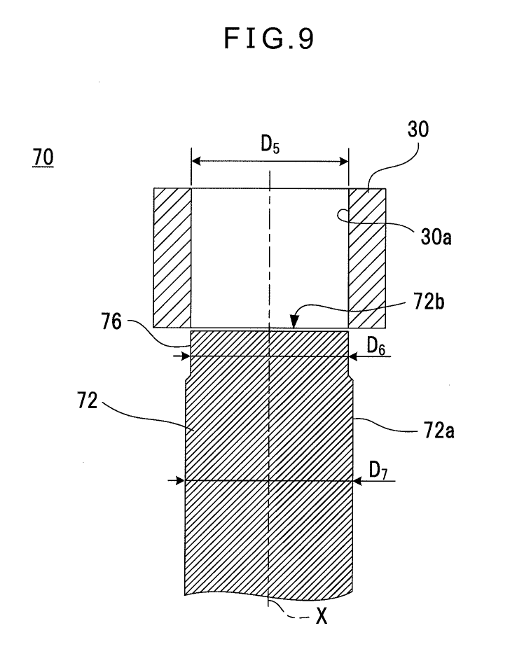

Next, another variant of the present invention will be described with reference to FIGS. 8 and 9. FIG. 8 is an exploded perspective view illustrating a yoke 30 and a rotational shaft 72 of a rotor 70 according to the variant. FIG. 9 is a sectional view illustrating the yoke 30 and the rotational shaft 72 shown in FIG. 8. In this variant, similarly to the above variants shown in FIGS. 6 and 7, the yoke 30 has a convex portion 34 on an inner circumferential surface 30a and the rotational shaft 72 has a concave portion 74 on an outer circumferential surface 72a. Since configuration of the yoke 30 is the same as that in the above variant described in relation to FIGS. 6 and 7, the detailed explanation thereon will be omitted. The concave portion 74 of the rotational shaft 72 has a fitting portion 74a and an enlarged portion 74b, similarly to the concave portion 36 of the rotational shaft 32 in the variant of FIG. 6. Specifically, the fitting portion 74a is sized so as to have a width smaller than a width of the convex portion 34 such that the fitting portion 74a is fitted on the convex portion 34 of the yoke 30 by interference fit. The enlarged portion 74b has a width defined in a direction perpendicular to the axis X of the rotational shaft 72 and the width gradually increases toward an end 74c of the concave portion 74.

As can be more clearly seen in FIG. 9, the rotational shaft 72 has a smaller diameter portion 76 at an end 72b directed to the side on which the yoke 30 is introduced. The smaller diameter portion 76 has an outer diameter D₆ smaller than an inner diameter D₅ of the yoke 30. Therefore, D₆<D₅<D₇ is satisfied, where D₅ is the inner diameter of the yoke 30, D₆ is the outer diameter of the smaller diameter portion 76 and D₇ is an outer diameter of the rotational shaft 72. With the rotor 70 having such configuration, the smaller diameter portion 76 serves as guiding means when the yoke 30 is mounted on the rotational shaft 72. Therefore, a mounting process is facilitated and is more efficient, and as a result, manufacturing cost can be reduced. The smaller diameter portion 76 preferably extends at least from the end 72b of the rotational shaft 72 to an end 74d of the enlarged portion 74b situated distant from the end 72b. With such configuration, the enlarged portion 74b and the smaller diameter portion 76 cooperate with each other over the area of the enlarged portion 74b, and therefore, a mounting process of the yoke 30 can be smoothly carried out. The smaller diameter portion 76 may also extend beyond the end 74d of the enlarged portion 74b. In this case, after the convex portion 34 of the yoke 30 and the concave portion 74 of the rotational shaft 72 are fitted together, the inner circumferential surface 30a of the yoke 30 and the outer circumferential surface 72a of the rotational shaft 72 are fitted together. Therefore, the yoke 30 can be prevented from being misaligned and unintentional great force can be prevented from acting on the yoke 30 or the rotational shaft 72.

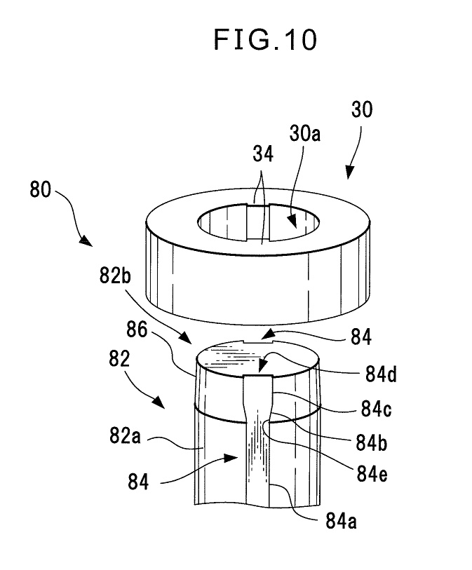

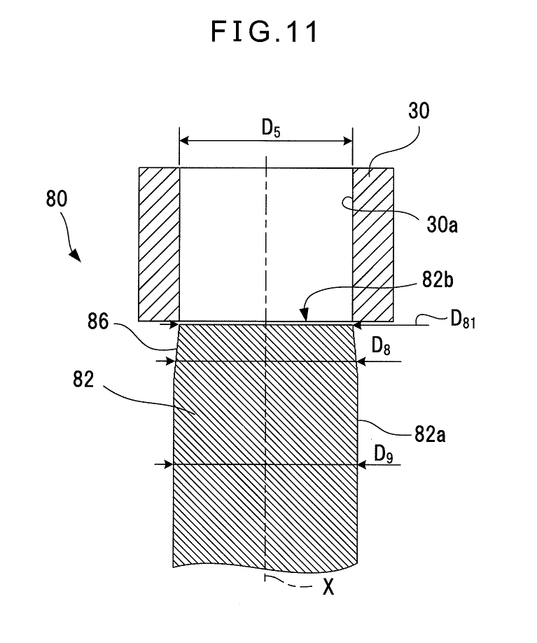

FIG. 10 is an exploded perspective view illustrating a yoke 30 and a rotational shaft 82 of a rotor 80 according to yet another variant of the present invention. FIG. 11 is a sectional view illustrating the yoke 30 and the rotational shaft 82 shown in FIG. 10. In this variant, similarly to the above variants shown in FIGS. 6 and 7, the yoke 30 has a convex portion 34 on an inner circumferential surface 30a and the rotational shaft 82 has a concave portion 84 on an outer circumferential surface 82a. Detailed explanation on the yoke 30 will be omitted. The concave portion 84 of the rotational shaft 82 has a fitting portion 84a, an enlarged portion 84b and a widened portion 84c, similarly to the concave portion 36 of the rotational shaft 32 according to the variant shown in FIG. 7. Specifically, the fitting portion 84a is sized so as to have a width smaller than a width of the convex portion 34 such that the fitting portion 84a is fitted on the concave portion 34 of the yoke 30 by interference fit. The enlarged portion 84b has a width defined in a direction perpendicular to the axis X of the rotational shaft 82, and the width gradually increases toward an end 84d of the concave portion 84. The widened portion 84c has a constant width in a direction perpendicular to the axis X of the rotational shaft 82. The width of the widened portion 84c is larger than a width of the convex portion 34 of the yoke 30 and equal to or larger than a width of the enlarged portion 84b of the rotational axis 82.

As can be more clearly seen in FIG. 11, the rotational shaft 82 has a smaller diameter portion 86 at an end 82b directed to the side on which the yoke 30 is introduced. The smaller diameter portion 86 has an outer diameter D₈ smaller than an inner diameter D₅ of the yoke 30. The smaller diameter portion 86 has a tapered shape so that the outer diameter D₈ gradually decreases toward the end 82b of the rotational shaft 82. Further, the smaller diameter portion 86 has at a tip end of the smaller diameter portion 86, or the end 82b of the rotational shaft 82, an outer diameter D₈₁ smaller than the inner diameter D₅ of the yoke 30. Therefore, D₈₁<D₅<D₉ is satisfied, where D₅ is the inner diameter of the yoke 30, D. is the outer diameter of the smaller diameter portion 86 at the tip end thereof and D₉ is an outer diameter of the rotational shaft 82. With the rotor 80 having such configuration, the smaller diameter portion 86 serves as guiding means when the yoke 30 is mounted on the rotational shaft 82. Therefore, a mounting process is facilitated and is more efficient, and as a result, manufacturing cost can be reduced. The smaller diameter portion 86 preferably extends from the end 82b of the rotational shaft 82 to an end 84e of the enlarged portion 84b situated distant from the end 82b. With such configuration, the enlarged portion 84b and the smaller diameter portion 86 cooperate with each other over the area of the enlarged portion 84b, and therefore, a mounting process of the yoke 30 can be smoothly carried out. In this variant, the smaller diameter portion 86 may also extend beyond the end 84e of the enlarged portion 84b.

Although the exemplary variants in which the concave portion is formed on the rotational shaft have been explained with reference to FIGS. 6 to 11, the same matters will be applied to embodiments in which the concave portion is formed on the yoke, rather than on the rotational shaft. If this is the case, it is evident that the enlarged portion 40, 74b or 84b, the widened portion 42 or 84c, or the smaller diameter portion 76 or 86 of the concave portion also serve as guiding means in the same way as explained in relation to the illustrated variants. Further, the enlarged portion 40, 74b or 84b, the widened portion 42 or 84c and the smaller diameter portion 76 or 86 may also be provided at the other end, which is not shown. With the enlarged portion 40, 74b or 84b, the widened portion 42 or 84c and the smaller diameter portion 76 or 86 provided at both ends, the yoke 30 can be easily mounted on the rotational shaft 32, 72 or 82 from either side thereof. This advantageously increases freedom of how the mounting process is carried out.

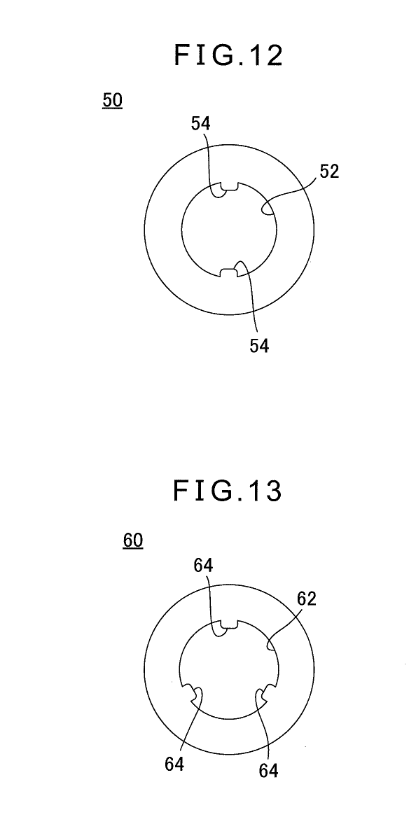

FIGS. 12 and 13 are sectional views illustrating yokes 50 and 60 of a rotor according to yet another variant, respectively. In these variants, the above-described fitting between the concave portion and the convex portion is evenly provided at a plurality of positions. Specifically, the concave portions and the convex portions are provided so as to be equally distant from each other on the inner circumferential surface of the yoke or the outer circumferential of the rotational shaft.

The yoke 50 shown in FIG. 12 has two convex portions 54 and 54 on an inner circumferential surface 52 of the yoke 50. The convex portions 54 and 54 are situated so as to be opposite to each other. Although not illustrated, the rotational shaft has two concave portions situated so as to be opposite to each other, corresponding to the convex portions 54 and 54. The yoke 60 shown in FIG. 13 has on an inner circumferential surface 62 three convex portions 64 at an equal distance from each other in a circumferential direction of the yoke 60, or in other words, distant from each other by 120 degrees. It is evident that the yoke may also have a plurality of concave portions at an equal distance from each other in a circumferential direction. In this case, the rotational shaft has a plurality of convex portions at an equal distance from each other in a circumferential direction, corresponding to the concave portions of the yoke.

As illustrated in FIGS. 12 and 13 by way of example, balance of the rotor during rotational movement can be maintained by providing the convex portions and the concave portions fitted thereon at an equal distance from each other in a circumferential direction, respectively. In the illustrated variants, two or three convex portions and concave portions are provided, the present invention is not limited to such particular configuration, but may also include configuration in which four or more convex portions and concave portions are provided at an equal distance from each other. The present invention is not limited to any particular embodiment expressly described in the present specification in relation to other embodiments, either. For example, it is evident to a person skilled in the art that it is possible to combine the embodiments and variants thereof described in the present specification in any way in order to implement the present invention.

### Effect of the Invention

According to the first aspect, fitting between the outer circumferential surface of the rotational shaft and the inner circumferential surface of the yoke is interference fit, and fitting between the concave portion and the convex portion of the rotational shaft and the yoke is interference fit. Therefore, a rotor in which the yoke and the rotational shaft are securely fitted on each other both in an axial direction and a rotational direction of the rotor can be provided without adhesive or separate fixing means. With such configuration, even in the case where the yoke undergoes plastic deformation when fitted on the shaft, the yoke and the shaft are securely fitted on each other, due to the interference fit between the concave portion and the convex portion. In contrast, in the related art, fitting between the concave portion and the convex portion is generally carried out by transition fit in the case where the yoke is most closely fitted on the shaft. In such a case, a gap may be formed between the concave portion and the convex portion. As a result, fastening force may be decreased upon plastic deformation of the yoke. Further, fretting may occur due to the gap between the concave portion and the convex portion.

According to the second aspect, the enlarged portion serves as guiding means when the concave portion and the convex portion are fitted on each other. This allows a mounting process for mounting the yoke on the rotational shaft to be facilitated.

According to the third aspect, the widened portion serves as guiding means, in addition to the enlarged portion. This allows a mounting process for mounting the yoke on the rotational shaft to be facilitated. Further, the widened portion can be formed relatively easily because it has a constant width.

According to the fourth aspect, the smaller diameter portion of the rotational shaft serves as guiding means when the yoke is fitted on the rotational shaft. Accordingly, the yoke can be smoothly introduced without slanting the yoke.

According to the fifth aspect, the smaller diameter portion extends at least over the area of the enlarged portion of the concave portion. The smaller diameter portion and the enlarged portion cooperate with each other to serve as guiding means, when the concave portion and the convex portion are fitted on each other. Therefore, a mounting process for mounting the yoke on the rotational shaft can be facilitated.

According to the sixth aspect, the smaller diameter portion has a tapered shape. Therefore, the yoke can be introduced smoothly.

According to the seventh aspect, the concave portions and the convex portions are provided on the rotor so as to be evenly distributed. This allows balance of the rotor during rotational movement to be maintained.

According to the eighth aspect, a manufacturing process can become relatively easier since the yoke is formed from steel plates stacked one on top of another and the steel plates are formed by means of punching. With the yoke having a stacked structure, an eddy current can be prevented from generating, and as a result, iron loss can be reduced.

Although the invention has been shown and described with exemplary embodiments thereof, it should be understood by a person skilled in the art that the foregoing and various other changes, omissions and additions may be made therein and thereto without departing from the spirit and scope of the invention.

What is claimed is:

1. A rotor for an electric motor comprising:
a rotational shaft having a cylindrical contour and capable of rotating around an axis; and
a yoke fitted on an outer circumferential surface of the rotational shaft, wherein the rotational shaft has on the outer circumferential surface at least one concave portion or convex portion extending in parallel to the axis, wherein
the yoke has on an inner circumferential surface a convex portion or a concave portion extending in parallel to the axis and adapted to be fitted on the at least one concave portion or convex portion of the rotational shaft, and wherein
fitting between the outer circumferential surface of the rotational shaft and the inner circumferential surface of the yoke is interference fit, and fitting between the concave portion or the convex portion of the rotational shaft and the convex portion or the concave portion of the yoke is interference fit.

2. The rotor according to claim 1, wherein the concave portion of the rotational shaft or the yoke has an enlarged portion having a width in a direction perpendicular to the axis, the width gradually increasing toward at least one end of the concave portion.

3. The rotor according to claim 2, wherein the concave portion of the rotational shaft or the yoke has a widened portion extending from a tip end of the enlarged portion and having a constant width in a direction perpendicular to the axis.

4. The rotor according to claim 1, wherein the rotational shaft has at at least one end of the rotational shaft a smaller diameter portion having an outer diameter smaller than an inner diameter of the yoke.

5. The rotor according to claim 2, wherein the rotational shaft has at at least one end of the rotational shaft a smaller diameter portion having an outer diameter smaller than an inner diameter of the yoke, the smaller diameter portion extending from the at least one end of the rotational shaft to an end of the enlarged portion situated distant from the at least one end of the rotational shaft.

6. The rotor according to claim 4, wherein the smaller diameter portion has a tapered shape which gradually decreases in an outer diameter toward the at least one end of the rotational shaft where the smaller diameter portion is situated.

7. The rotor according to claim 1, wherein a plurality of the concave portions or the convex portions are situated on the outer circumferential surface of the rotational shaft or the inner circumferential surface of the yoke at an equal distance from each other.

8. The rotor according to claim 1, wherein the yoke has a stacked structure of steel plates.
